(19) United States
(12) Patent Application Publication
(10) Pub. No.: US 2017/0090801 A1
(43) Pub. Date: Mar. 30, 2017

(54) SYSTEM FOR STORING AND READING OF A MESSAGE AUTHENTICATION CODE IN AN EXTERNAL MEMORY AND RELATED METHOD

(71) Applicant: STMICROELECTRONICS (ROUSSET) SAS, Rousset (FR)

(72) Inventor: Albert MARTINEZ, Bouc Bel Air (FR)

(21) Appl. No.: 15/050,854

(22) Filed: Feb. 23, 2016

(30) Foreign Application Priority Data
Sep. 24, 2015 (FR) 1559009

(51) Int. Cl. G06F 3/06; G06F 12/08

(52) U.S. Cl. CPC G06F 3/0623; G06F 3/0619; G06F 3/0659; G06F 3/0685; G06F 12/0802; G06F 2212/401; G06F 2212/60

(57) ABSTRACT

A method is for protecting a program code that is executed by a computer processing module having a central processing unit coupled to a cache memory containing cache lines that each have a data field that is intended to store instruction words that can be executed by the central processing unit. The method includes storing the program code in memory locations of an external memory with respect to the computer processing module, each memory location being capable of storing the instruction words of one cache line. The method also includes determining authentication codes that are respectively associated with the cache lines and, for each cache line, fragmenting the associated authentication code and storing this distributed fragmented authentication code in the corresponding memory location.

### TECHNICAL FIELD

The present disclosure relates to a system for the protection of program codes stored in an external memory, for example of FLASH NOR type, that are to be executed by a computer processing module, and to a related method.

### BACKGROUND

A computer processing module can have not only a microprocessor but also a cache memory allowing it to store recently used program code so as to access the program code more quickly in the event of possible reuse. If the program code is not present in the cache memory, it is transferred from a higher-level memory to the cache memory. During this transfer, the program code may be the target of attackers that have modified or replaced the program code with malicious code. It is therefore desirable, notably for critical applications, to check the integrity of the transferred program code.

Methods allowing the integrity of a program code to be checked are known that use message authentication codes, which are commonly denoted by the acronym “MAC”.

A message authentication code is a code that accompanies data with the aim of ensuring the integrity thereof by allowing a check to determine that they have not undergone any modification following a transmission from an external memory to a microprocessor, for example.

At present, the message authentication code can be stored either in an area of the external memory that is different from the one that contains the program code, in which case reading of the authentication code requires a second read access, or in the same memory location as the program code, subsequently thereto, but this case is not compatible with wraps.

### SUMMARY

One embodiment of the present disclosure provides a method for storing message authentication codes in split fashion in program code.

According to another aspect, the method includes protecting the program code that is intended to be executed by a central processing unit of a computer processing module. The central processing unit may be coupled to a cache memory containing cache lines that each have a data field that is intended to store instruction words that can be executed by the central processing unit. The method may include storing the program code in memory locations of an external memory with respect to the computer processing module, each memory location being capable of storing the instruction words of one cache line. The method may also include determining authentication codes that are respectively associated with the cache lines and, for each cache line, fragmenting the associated authentication code and storing this distributed fragmented authentication code in the corresponding memory location.

Thus, during a request by the computer processing module for a program code instruction line, the program code and the authentication code are read simultaneously. Moreover, this aspect is compatible with wraps.

According to another aspect, each memory location may contain memory words that respectively store the words of the corresponding cache line, each memory word has a storage capacity above that of the instruction word and contains an area that is not used for storing the instruction word, and the fragments of the authentication code that are associated with the instruction words of the cache line are stored in at least some of the unused areas.

The method may further include, during a request by the central processing unit for an instruction word that is not present in a cache line of the cache memory, extraction, from the external memory, of the instruction words of the corresponding cache line and of the associated fragmented authentication code, reconstruction of the authentication code from said fragments, computation of the authentication code from the extracted instruction words, and comparison of the computed authentication code with the reconstructed authentication code.

According to another aspect, each memory location contains memory words that respectively store the words of the corresponding cache line, each memory word has a storage capacity equal to that of the instruction word, and the storage of the program code includes compression of at least some of the instruction words of each cache line and storage of the compressed instruction words in the corresponding memory words. This storage provides for a free area to remain in the corresponding memory word, and the fragments of the authentication code that are associated with the compressed instruction words of the cache line are stored in the free areas.

Thus, this aspect may dispense with the use of memory words of a size above that of the instruction words, because the compression of the instruction words makes it possible to obtain free areas in the memory words and to store the authentication code therein.

The compression may be performed either by an algorithm making it possible to obtain compressed words of variable size or by an algorithm making it possible to obtain compressed words of fixed size.

The method may further include during a request by the central processing unit for an instruction word that is not present in a cache line of the cache memory, extraction, from the external memory, of the instruction words of the corresponding cache line and of the associated fragmented authentication code, reconstruction of the authentication code from the fragments, decompression of the compressed instruction words, computation of the authentication code from the decompressed instruction words, and comparison of the computed authentication code with the extracted authentication code.

According to another aspect, a system is disclosed that includes a computer processing module containing a central processing unit, and a cache memory containing cache lines that each have a data field that is intended to store instruction words that can be executed by the central processing unit of the computer processing module. The system may also include an external memory with respect to the computer processing module including memory locations corresponding to data fields of cache lines, each memory location being configured to store the instruction words of a cache line, and a controller that is configured to determine authentication codes that are respectively associated with the cache lines, to fragment the associated authentication code and to store this distributed fragmented authentication code in the corresponding memory location.

Each memory word of each memory location may have a storage capacity above that of the instruction word and contain an area that is not used for storing the instruction word, and at least some of said unused areas are capable of receiving the fragments of the authentication code that is associated with the instruction words of the cache line.

The controller is configured to, during a request by the central processing unit for an instruction word that is not present in a cache line of the cache memory, extract, from the external memory, the instruction words of the corresponding cache line and the associated fragmented authentication code, reconstruct the authentication code from the fragments, compute the authentication code from the extracted instruction words, and compare the computed authentication code with the reconstructed authentication code.

According to another aspect, each memory location contains memory words that respectively store the words of the corresponding cache line, each memory word has a storage capacity equal to that of the instruction word, and is capable of receiving compressed, or otherwise, instruction words to allow a free area to remain in the memory word that is capable of receiving a fragment of the authentication code that is associated with the compressed instruction words of the cache line.

The controller can advantageously be configured to compress the instruction words to form compressed words of equal size or to form compressed words of variable size.

### DETAILED DESCRIPTION OF THE DRAWINGS

Other advantages and features of the invention will emerge upon examining the detailed description of implementations and embodiments, which are in no way restrictive, and the appended drawings, in which:

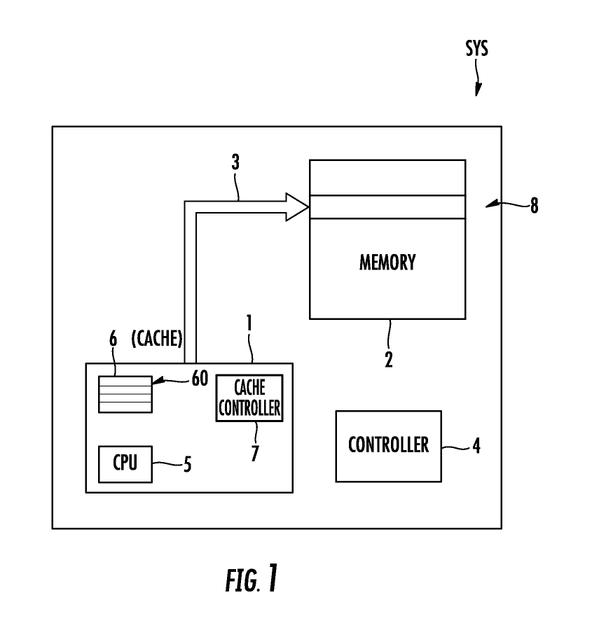

FIG. 1 is a schematic diagram of a system to protect message authentication codes in an external memory according to the invention;

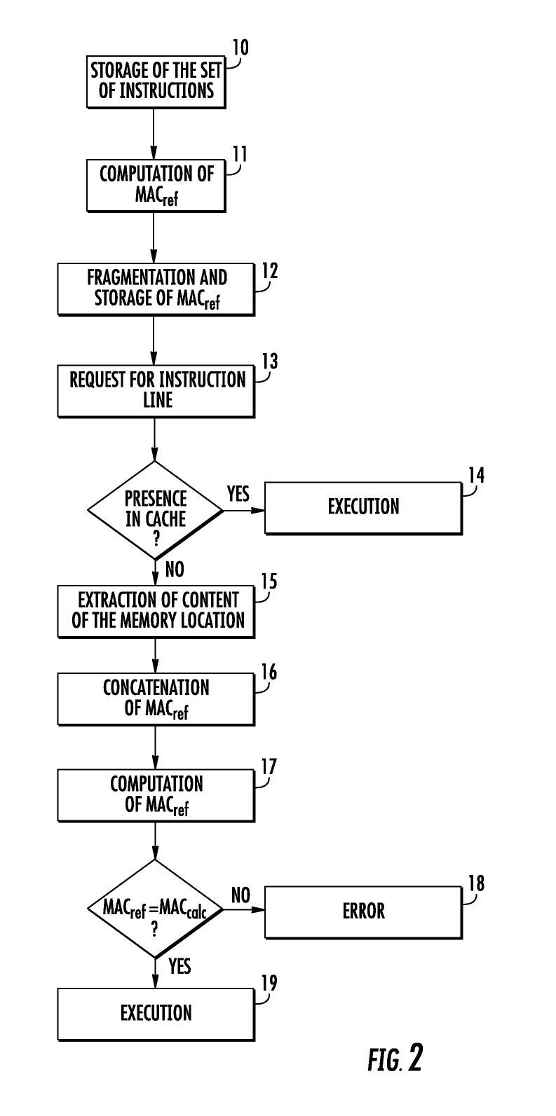

FIG. 2 is flow diagram of a method to protect message authentication codes in an external memory according to the invention;

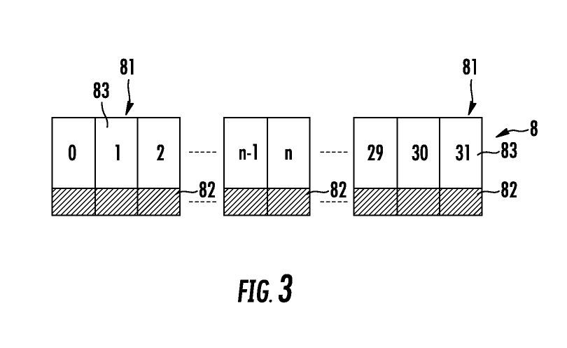

FIG. 3 is a schematic diagram of locations within a memory according to the invention;

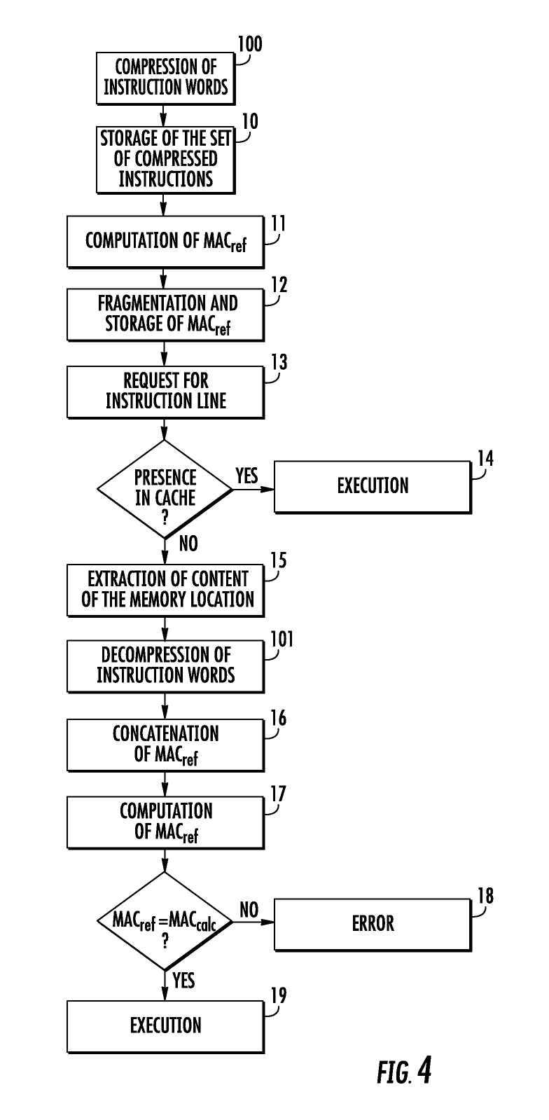

FIG. 4 is a flow diagram of another embodiment of a method to protect authentication codes in an external memory according to the invention;

FIG. 5 is a schematic diagram of storing words of fixed size in locations within the memory according to the invention; and

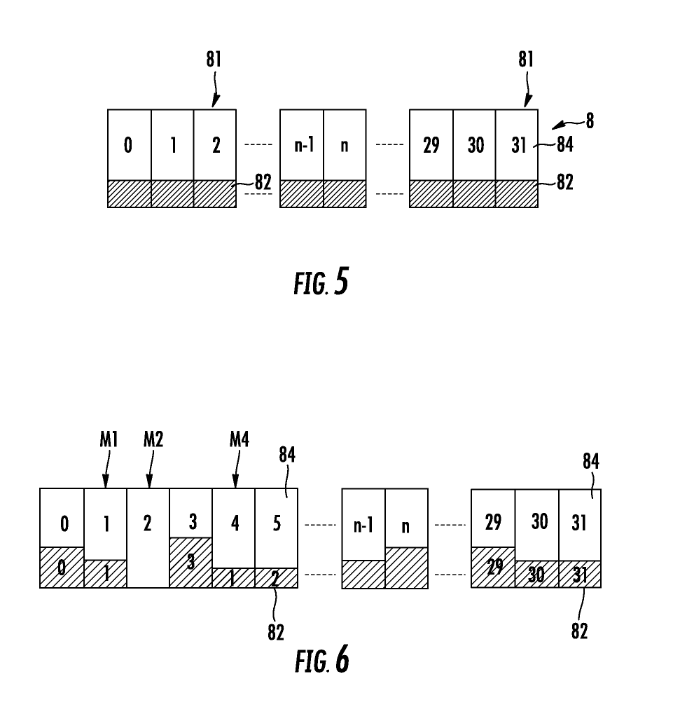

FIG. 6 is a schematic diagram of storing words of variable size in locations of the memory according to the invention.

### DETAILED DESCRIPTION

FIG. 1 shows a system SYS comprising a computer processing module 1, for example a microprocessor, coupled to an external memory 2, for example of FLASH NOR type, via a communication bus 3.

The system SYS likewise comprises a controller 4 that is configured to perform decompression and/or concatenation operations on data that are interchanged between the processing module 1 and the external memory 2. These operations will be seen in more detail below.

In this example, the processing module 1 includes a microprocessor 5, a level-1 cache 6 having cache lines 60 that is intended to receive instruction words 83 of a program code and a cache controller 7. In this example, the cache comprises cache lines that may receive thirty-two words of 16 bits each.

The external memory includes memory locations 8 that are each configured to receive instruction words 83 of a program code corresponding to a cache line and a message authentication code that is associated with the cache line.

FIG. 2 schematically shows the various steps of an implementation of the invention. For example, in step 10, the program code is stored in the memory locations 8.

As illustrated in FIG. 3, in a memory location 8, each instruction word 83 of a cache line is stored in a memory word 81 of a size above that of the instruction words 83, so that a free area 82 remains therein following the storage of the instruction word 83.

In this case, for example, the memory words 81 of the external memory are words of 18 bits, 16 bits of which are intended to store the instruction words 83 and two bits of which are supplementary bits. Each memory location 8 is therefore capable of storing the 32 instruction words 83 of a cache line in the 32 memory words 81 of 18 bits by leaving a free space of 32×2 bits that is distributed over the 32 memory words 81.

In the example described here, these free areas 82 are situated at the end of the memory words 81. As a variant, they could be situated at the start of the memory words 81 or else at any known position for these patterns 81.

In step 11, a message authentication code MAC referenced MAC_{ref} is computed from the program code that is present in the memory location 8. By way of example, a message authentication code is obtained conventionally by an algorithm using, as input, the message to be transmitted and a coding key in order to obtain, as output, the authentication code. This algorithm, which is similar to the hash functions that are well known to a person skilled in the art, does not need to be reversible. It makes it possible to ensure the integrity and authenticity of the transmitted data.

Step 12 includes fragmentation of the authentication code MAC_{ref} associated with the 32 instruction words 83 so as to distribute it in this case in the free areas 82 of the 32 memory words 81. It might not be necessary to use the 32 free areas 82 for storing the fragments MAC_{ref}, but just some of the free areas, for example.

It should be noted at this juncture that the computation of the codes MAC_{ref} and the fragmentation thereof could be performed before storage of the instruction set and followed by simultaneous storage of the instruction set and fragmented codes MAC_{ref} in the memory.

Next at step 13, if the central processing unit 5, in this case a microcontroller, makes a request for an instruction word 83, the cache controller 7 checks the presence of the instruction word 83 in a cache line of the cache 6 of the computer processing module 1.

If the instruction word is present in a cache line of the cache 6, then the instruction is executed, at step 14, by the microcontroller 6.

The opposite case, at step 15, is referred to as a cache miss. The cache controller then makes a request to the external memory 2 so that the content of the memory location 8 storing the cache line containing the required instruction word is transmitted to it.

It should be noted that a cache line is the smallest element that can be transferred between the cache memory 6 and the external memory 2. Upon each request for an instruction word 83, all of the words 81 in the memory location 8 are therefore transferred, rather than just the memory word 81 containing the instruction word 83.

By way of example, if the required instruction word is situated in position n in the memory location, then the words 81 from the n-th to the last word 81 of the line will be extracted, and then the words from the first in the line to word n−1 will be extracted, in accordance with the operation of a wrap.

Next, at step 16, the controller 4 uses concatenation to reconstruct the message authentication code MAC_{ref} from the fractions distributed in the free areas 82 of each of the memory words 81 received from the memory location 8.

This concatenation is possible whatever the order of extraction of the instruction words.

The controller 4 likewise computes, at step 17, a message authentication code MAC_{calc} from the content of the instruction words 83 received during the transfer, and then compares the computed code MAC_{calc} with the reconstructed authentication code MAC_{ref}.

If the two codes are not identical, at step 18, this indicates that the program code has been modified. The controller 4 then generates an error.

If the two codes are identical, at step 19, then this indicates that the integrity and authenticity of the program code is verified, and the program code can be executed in secure fashion by the microcontroller 5.

FIG. 4 illustrates another embodiment, which is similar to the method described above and illustrated by FIG. 2, but further includes two supplementary steps 100 and 101.

In this embodiment, the memory locations 8 include memory words 81 of identical size to the size of the instruction words 83, for example in this case memory locations having thirty-two words of 16 bits.

The first step 100 corresponds to compression of the instruction words 83 prior to step 10 of storage in the memory locations of the external memory.

This compression can be performed in accordance with a deterministic algorithm making it possible to obtain compressed instruction words 84 of fixed size (FIG. 5), in which case the words are stored in the memory words 81 and the free areas 82 are likewise of fixed size. By way of example, the compressed words 84 make 15 bits and there therefore remains one bit per word for storing the authentication code fractions, or in accordance with a variable coding algorithm making it possible to obtain compressed instruction words 84 of variable size (FIG. 6), in which case the compressed words 84 are stored in the memory words 81 and the free areas 82 are of variable size, some words 81 possibly not comprising free areas if the corresponding word 83 cannot be compressed. By way of example, the first memory word M1 comprises a compressed word of 15 bits, and an authentication code fraction of I bit, whereas the fourth memory word M4 comprises a compressed instruction word of 13 bits and an authentication code fraction of 3 bits. The third memory word M3, for its part, does not have a compressed instruction word.

The bits corresponding to the instruction words are compressed, and those corresponding to the authentication code are not.

Step 101, which follows the extraction of the content of the memory location 8, corresponds to decompression of the compressed instruction words 84.

In this case, for example, the controller 4 can include a hardware decompressor, which allows rapid decompression of the data.

It should be noted that the implementations and embodiments presented here are in no way restrictive. Notably, although a flash NOR memory has been involved in this case, the invention can likewise be applied to DRAM (Dynamic Random Access Memory) memories.

Furthermore, although a cache memory 6 situated in the computer processing module 1 has been described above, the cache memory could be situated outside the processing module. In particular, the cache memory could be formed by a buffer memory situated in the interface of the FLASH memory 8.

Moreover, whereas the description above concerned execution of the program code by the microprocessor 5 only if the reconstructed authentication code MAC_{ref} is identical to the computed authentication code MAC_{calc}, it is quite possible for the execution of the program code to start during the computation of the code MAC_{calc} and the comparison of the two codes MAC_{ref} and MAC_{calc}, and to be interrupted in the event of the comparison indicating that the two codes MAC_{ref} and MAC_{calc} are not identical.

1-13. (canceled)

14. A method for protecting a program code to be executed by a central processing unit (CPU) of a computer processing module, the CPU coupled to a cache memory having a plurality of cache lines, each cache line having a data field to store a plurality of instruction words configured to be executed by the CPU, the method comprising:
storing the program code in a plurality of memory locations of an external memory with respect to the computer processing module, each memory location configured to store the plurality of instruction words of a respective cache line;
determining an authentication code respectively associated with each cache line;
fragmenting, for each cache line, the associated authentication code; and
storing associated fragments of the authentication code in a corresponding memory location of the external memory.

15. The method according to claim 14, wherein each memory location of the external memory has a plurality of memory words configured to respectively store the plurality of instruction words of the corresponding cache line, each memory word having a storage capacity above that of a given instruction word and a free area not used for storing the given instruction word, and storing the fragments of the authentication code that are associated with the plurality of instruction words of the cache line.

16. The method according to claim 15, further comprising during a request by the central processing unit for a given instruction word that is not present in the corresponding cache line of the cache memory:
extracting, from the external memory, the plurality of instruction words of the corresponding cache line and the associated fragments of the authentication code;
reconstructing the authentication code from the associated fragments to form a reconstructed authentication code;
computing the authentication code from the extracted plurality of instruction words to form a computed authentication code; and
comparing the computed authentication code with the reconstructed authentication code.

17. The method according to claim 14, wherein each memory location having a plurality of memory words is configured to respectively store the plurality of instruction words of the corresponding cache line, each memory word having a storage capacity equal to that of a given instruction word.

18. The method according to claim 17, wherein the storing of the program code further comprises compression of at least one of the plurality of instruction words of each cache line and storing the at least one compressed instruction word in a corresponding memory word, a free area to remain in the corresponding memory word, and the associated fragments of the authentication code associated with the at least one compressed instruction word are stored in the free area of the corresponding memory word.

19. The method according to claim 18, wherein the compression is performed in accordance with a deterministic coding algorithm, the free areas being of equal size.

20. The method according to claim 18, wherein the compression is performed in accordance with a variable coding algorithm, the free areas being of variable size.

21. The method according to claim 18, further comprising, during a request by the central processing unit for an instruction word that is not present in a given cache line of the cache memory:
extracting, from the external memory, the at least one compressed instruction word of the corresponding cache line and the associated fragments of the authentication code;
reconstructing the authentication code from the fragments;
decompressing the at least one compressed instruction word;
computing the authentication code from the decompressed at least one instruction word; and
comparing the computed authentication code with the extracted authentication code.

22. A system for protecting a program code comprising:
a computer processing module having a central processing unit;
a cache memory having a plurality of cache lines, each having a data field to store an instruction word that can be executed by the central processing unit of the computer processing module;
an external memory with respect to the computer processing module comprising a plurality of memory locations corresponding to data fields of the plurality of cache lines, each memory location being configured to store a plurality of instruction words of a cache line; and
a controller configured to determine an authentication code that is respectively associated with each cache line of the plurality of cache lines, fragment the associated authentication code, and store the associated fragments of the authentication code in a corresponding memory location.

23. The system according to claim 22, wherein each memory word of each memory location has a storage capacity above that of a given instruction word and contains a free area not used for storing the given instruction word, and the free area of the memory location configured to receive the associated fragments of the authentication code that are associated with the plurality of instruction words of the cache line.

24. The system according to claim 22, wherein the controller is configured to, during a request by the central processing unit for an instruction word that is not present in a cache line of the cache memory:
extract, from the external memory, the plurality of instruction words of the corresponding cache line and the associated fragments of the authentication code,
reconstruct the authentication code from the associated fragments to form a reconstructed authentication code,
compute the authentication code from the extracted plurality of instruction words to form a computed authentication code, and
compare the computed authentication code with the reconstructed authentication code.

25. The system according to claim 22, wherein each memory location has a plurality of memory words to respectively store the plurality of instruction words of the corresponding cache line, each memory word having a storage capacity equal to that of a given instruction word and configured to receive the plurality of instruction words, a free area to remain in a corresponding memory word configured to receive a fragment of the authentication code that is associated with the plurality of instruction words of the corresponding cache line.

26. The system according to claim 25, wherein the controller is configured to compress the plurality of instruction words to form a plurality of compressed words of equal size.

27. The system according to claim 25, wherein the controller is configured to compress the plurality of instruction words to form a plurality of compressed words of variable size.

28. A system for protecting a program code comprising:
a computer processing module having a central processing unit;
a cache memory having a plurality of cache lines configure to store a plurality of instruction words that can be executed by the central processing unit of the computer processing module;
an external memory comprising a plurality of memory locations corresponding to data fields of the plurality of cache lines, each memory location being configured to store the plurality of instruction words of the corresponding cache line; and
a controller configured to fragment the associated authentication code, and store the associated fragments of the authentication code in a corresponding memory location;
wherein a storage capacity of each memory word has a storage capacity above that of a given instruction word and contains a free area to store the associated fragments of the authentication code that are associated with the plurality of instruction words of the cache line.

29. The system according to claim 28, wherein the controller is configured to extract the plurality of instruction words of the corresponding cache line and the associated fragments of the authentication code from the external memory, reconstruct the authentication code from the associated fragments to form a reconstructed authentication code, compute the authentication code from the extracted plurality of instruction words to form a computed authentication code, and compare the computed authentication code with the reconstructed authentication code.

30. The system according to claim 28, wherein a storage capacity of the corresponding cache line is equal to that of a given instruction word.

31. The system according to claim 30, wherein the corresponding cache line is configured to receive compressed, or otherwise, the plurality of instruction words, and having a free area to remain in a corresponding memory word configured to receive a fragment of the authentication code.

32. The system according to claim 31, wherein the controller is configured to compress the plurality of instruction words to form a plurality of compressed words of equal size.

33. The system according to claim 31, wherein the controller is configured to compress the plurality of instruction words to form a plurality of compressed words of variable size.
